(19) United States
(12) Patent Application Publication
(10) Pub. No.: US 2011/0236532 A1
(43) Pub. Date: Sep. 29, 2011

(54) FOOD COMPOSITION COMPRISING GERMINATED SEEDS OR GRAINS

(76) Inventor: Kari Seguin-Laur, Dundas (CA)

(21) Appl. No.: 12/773,214

(22) Filed: May 4, 2010

(30) Foreign Application Priority Data
Mar. 24, 2010 (CA) 2,697,758

(51) Int. Cl. A23K 1/16; A23K 1/20

(52) U.S. Cl. 426/61

(57) ABSTRACT

A probiotically and prebiotically active pet food comprising a germinated seed or grain is provided. The pet food also includes probiotic bacteria; a ground dry carbohydrate; and a humectant. The pet food is preferably formulated as a dry baked biscuit or a semi-moist biscuit. It provides a nutritious pet food with prebiotic and probiotic benefits. The invention also provides a method of preparing a probiotically and prebiotically active pet food composition comprising the steps of providing a pre-mix composition comprising a germinated seed or grain; a ground dry carbohydrate; probiotic bacteria and a humectant; blending the pre-mix composition with water; mixing the pre-mix composition to form a pet food composition; cooking the pet food composition in an oven at an internal temperature of the pet food composition of not greater than about 120° C. for about 10 minutes to 20 minutes.

### RELATED APPLICATIONS

This application claims the foreign priority benefit under 35 U.S.C. §119 of applicant's Canadian Patent Application No. ______ filed on Mar. 24, 2010, entitled “Food Composition Comprising Germinated Seeds or Grains,” the entire disclosure of which is incorporated herein by reference.

### BACKGROUND

1. Field of the Invention

The present invention relates to a food composition having probiotic and prebiotic properties that includes germinated seeds or grains.

2. Background of the Invention

Promoting the health of pets by providing a nutritionally balanced diet is extremely important to pet owners. Pet foods that provide acceptable levels of vitamins, proteins, carbohydrate and fats are available in the marketplace. Pet foods are also increasingly available that provide a diet that includes essential fatty acids and fiber.

It is well known that prebiotics have nutritional benefits in foods. Prebiotics are non-digestible elements in foods that promote the growth of beneficial bacteria in the digestive system. This results in health benefits. Probiotics are live microorganisms that provide digestive benefits. Lactic acid bacteria and bifidobacteria are known to provide probiotic benefits. It would therefore follow that it would be beneficial to the health of pets to include prebiotic and probiotic ingredients in a pet food. There is therefore a need for a pet food having a prebiotic and probiotic ingredient having health benefits for pets.

In preparing pet foods, the nutritional benefits of prebiotic and probiotic ingredients can be compromised by several processing factors including specific ingredients used in the formulation and exposure to heat during the cooking process. It is especially difficult to preserve the prebiotic and probiotic activity of the food given that commonly used preservatives in foods kill the beneficial bacteria that provide a probiotic effect. In addition, conventional cooking techniques for pet foods also kill lactic acid bacteria and bifidobacteria.

Since pet foods generally contain meat products, it is necessary to ensure that the pet food is processed in a manner that prevents the proliferation of pathogenic bacteria. It is a further challenge to formulate pet foods in manner that permits the survival of at least some probiotic bacteria while preventing the proliferation of pathogenic bacteria.

There is a need for a pet food composition and a method for making same, having ingredients that that allow for the preservation of probiotic, prebiotic and other nutritional benefits of foods through processing and cooking while preventing the proliferation of pathogenic bacteria.

### SUMMARY OF THE INVENTION

The present invention is a probiotically and prebiotically active food composition comprising a germinated seed or grain.

According to one aspect of the invention, there is provided a probiotically and prebiotically active food composition comprising a germinated seed or grain; a ground dry carbohydrate, probiotic bacteria, and a humectant. Preferably, the food composition is substantially free of added salts and refined sugars.

According to another aspect of the invention, there is provided a method of preparing a probiotically and prebiotically active food composition comprising the following steps:

providing a pre-mix composition comprising a germinated seed or grain; a ground dry carbohydrate; probiotic bacteria and a humectant; blending the pre-mix composition with water;

mixing the pre-mix composition to form a food composition; and cooking the food composition in an oven at an internal temperature of the food composition of not greater than about 120° C. for about 10 minutes to 20 minutes.

According to another aspect of the invention, there is provided a method of preparing a probiotically and prebiotically active food composition comprising the following steps:

providing a pre-mix composition comprising a germinated seed or grain; a ground dry carbohydrate; probiotic bacteria and a humectant; blending the pre-mix composition with water; mixing the pre-mix composition to form a food composition; pasteurizing the food composition in a first oven zone, the first oven zone being set to create an internal temperature of the food composition of between 90° C. and 120° C.; cooking the food composition in a second oven zone, the second oven zone being set to create an internal temperature of the food composition of between 70° C. and 120° C.; and cooking the food composition in a third oven zone, the third oven zone being set to create an internal temperature of the pet food composition of between 50° C. and 120° C.

### IN THE FIGURES

FIG. 1 is a table showing the content of microorganisms including lactobacillus, in a semi-moist pet food of the present invention at various time intervals of storage; and

FIG. 2 is a table showing the content of microorganisms including lactobacillus, in a dry biscuit pet food of the present invention at various time intervals of storage.

### DESCRIPTION OF THE INVENTION

The present invention is a food composition. The food compositions of the present invention include edible food compositions including complete foods which provide a nutritionally balanced diet and food supplements which include pet treats in the case of pet foods. The food compositions of the present invention are preferably pet foods that are formulated for dogs and cats. The food compositions can be formulated for other animals. In addition, the food compositions of the present invention can also include food compositions for human consumption. The food composition will be described hereafter as a pet food composition. It is to be understood that the following description of the pet food composition can also apply to human food compositions and food compositions for cats, dogs and other animals.

The present invention includes a probiotically and prebiotically active food composition. A prebiotically active food composition is a food composition that includes an ingredient that stimulates the growth of healthy bacteria such as bifidobacteria and lactobacilli in the gut and increases the resistance of the human or animal consuming the food composition to invading pathogens. A probiotically active pet food composition is a pet food composition that includes added live microorganisms that provide digestive benefits. Such microorganisms include lactic acid bacteria and bifidobacteria. Within the meaning of the present invention, a probiotically active food composition is a food composition that has a sufficient amount of live beneficial bacteria such as lactic acid bacteria and bifidobacteria after processing and cooking the food composition to provide digestive benefits to the human or animal that consumes the food composition.

Prebiotics are a dietary fibre that trigger the growth of bacteria having favourable effects on the intestinal flora. The preferred prebiotic ingredients for the purposes of the present invention are germinated seeds or grains. The most preferred prebiotic ingredient is germinated flax seed or sprouted flax seed. The terms “germinated seed” and “sprouted seed” have equivalent meanings Germinated seeds and grains that are suitable for the pet food composition of the present invention include chia seed, rice, whole grain wheat, oat, buckwheat, broccoli seed, carrot seed, adzuki bean, almond, amaranth, annatto seed, anise seed, argula, basil, brown rice, navy bean, pinto bean, lima bean, cabbage canola seed, caragana, cauliflower, celery, chick peas, chives, cilantro/coriander/dhania, clover, cress, dill fennel, fenugreek, garlic, hemp, kale, kamut, kat, leek, green lentil, lupins, pearl millet, mizuna, mustard, onion, black-eyed peas, green peas, pigeon peas, snow peas, peanut, psyllium, quinoa, radish, rye, sesame, soybean, tatsoi, triticale, water cress and wheat berries.

In addition other acceptable prebiotic ingredients include inulin, FOS (fructooligosaccharide), MOS (Mannooligosaccharide).

The germinated seeds or grains can be provided in raw, dehydrated, granulated or powdered form. In addition to the probiotic and prebiotic benefits, the preferred germinated seed, germinated flax seed, provides a source of omega-3 fatty acids, fiber, protein, vitamins and minerals.

Preferably, the pet food composition includes about 10% to about 90% by weight of germinated seed or grains. Most preferably, the pet food composition includes about 20%-30% by weight of germinated seed or grains.

The pet food composition includes a ground dry carbohydrate which is preferably in powdered form. The preferred ground dry carbohydrate is a grain flour which is preferably ground barley flour or ground amaranth flour. Other grain flours such as wheat flour or rice flour may be used. Alternatively, the ground dry carbohydrate can be a product of ground seed. Preferably, the pet food composition includes 10% to 90% by weight of the ground dry carbohydrate Most preferably, the pet food composition includes about 40% to about 50% by weight of the ground dry carbohydrate

The pet food composition of the present invention includes a humectant. The most preferred humectant is molasses. A preferred humectant is honey. Other acceptable humectants include gelatin, glycerol and sorbitol. Preferably, the pet food composition includes about 1% to about 30% by weight of the humectant. Most preferably, the pet food composition includes about 5% to 12% by weight of the humectant.

The pet food composition of the present invention preferably includes an edible oil which is preferably a vegetable oil. The preferred vegetable oil is Canola oil. Preferably, the pet food composition includes about 1% to about 30% by weight of the vegetable oil. Most preferably, the pet food composition includes about 5% to 12% by weight of the vegetable oil. Alternatively, another non-aqueous liquid could be used in the place of the oil.

The pet food compositions preferably include a meat product such as, but not limited to, chicken, salmon or beef. Because the pet food preferably includes meat, it is necessary to formulate and cook the pet food composition in a manner that prevents the proliferation of pathogenic bacteria associated with meats but without preventing the growth of the beneficial probiotic bacteria.

Other ingredients include ground oats, ground brown rice and sweet potato.

The pet food composition has vitamins and minerals including Dicalcium Phosphate, Vitamin E Acetate, Choline Chloride, Zinc Sulphate, Vitamin A Palmitate, Vitamin D3 Supplement, Copper Sulphate, Vitamin B2, Calcium Pantothenate, Mixed Tocopherols and Beta Carotene.

An important property of the pet food composition is the water activity. Water activity is a measure of water content. In the present context, this value represents how much water is available to support bacterial growth. For the purposes of the present invention, it is important to formulate the pet food composition such that the water activity is at a level that favours the growth of beneficial bacteria such as lactic acid bacteria and bifidobacteria over pathogenic bacteria. Beneficial bacteria are generally more robust than pathogenic bacteria. Hence a water activity is selected that is adequate for the growth of beneficial bacteria while not necessarily being ideal. At the preferred water activity level, the beneficial bacteria will survive at a significantly greater rate than the pathogenic bacteria. The proliferation of beneficial bacteria over the pathogenic bacteria will kill off the pathogenic bacteria due to their inability to compete with the beneficial bacteria. Water activity values of 0.1 to 0.8 A_{w} are acceptable for the purposes of the present invention. The preferred range is 0.2 to 0.6 A_{w}.

Conventional food preparation techniques employ preservatives and other ingredients that eliminate bacteria and other microbes, such as fungi, from foods. Such techniques are not acceptable for preparing a food product that is probiotically active. It is important that the pet food composition include levels of ingredients such as salts, refined sugars, and acidic ingredients such as vinegar that do not prevent the growth of beneficial bacteria. The pet food composition should include less than 1% by weight of added salt and less than 3% by weight of refined sugar.

The pet food composition preferably has a pH of about 6.5.

The pet food composition may be formulated as a dry or semi-moist pet food. Preferably, the pet food composition of the present invention is formulated as dry baked biscuits or semi-moist biscuits. The pet food composition may also be formulated as a dry or semi-moist kibble, pet treats with or without flour, which may be dry, moist or semi-moist. Additionally, the pet food composition can be formulated as a homogenous mixture, or could contain distinct particles, a coating or a filling.

The dry formulation preferably has 5-30% crude protein, 1-25% crude fat, 5-25% crude fiber, and 2-20% moisture.

The semi-moist formulation preferably has 5-30% crude protein, 1-25% crude fat, 5-25% crude fiber, and 2-30% moisture.

Preferred semi-moist and dry biscuits of the present invention have a fructooligosaccharide concentration of about 10.71 mg/g. In addition, the preferred semi-moist and dry biscuits of the present invention have a mannooligosaccharide concentration of about 8.65 mg/g. The amount of inulin in the preferred the semi-moist and dry biscuits is about 0.10 mg/g.

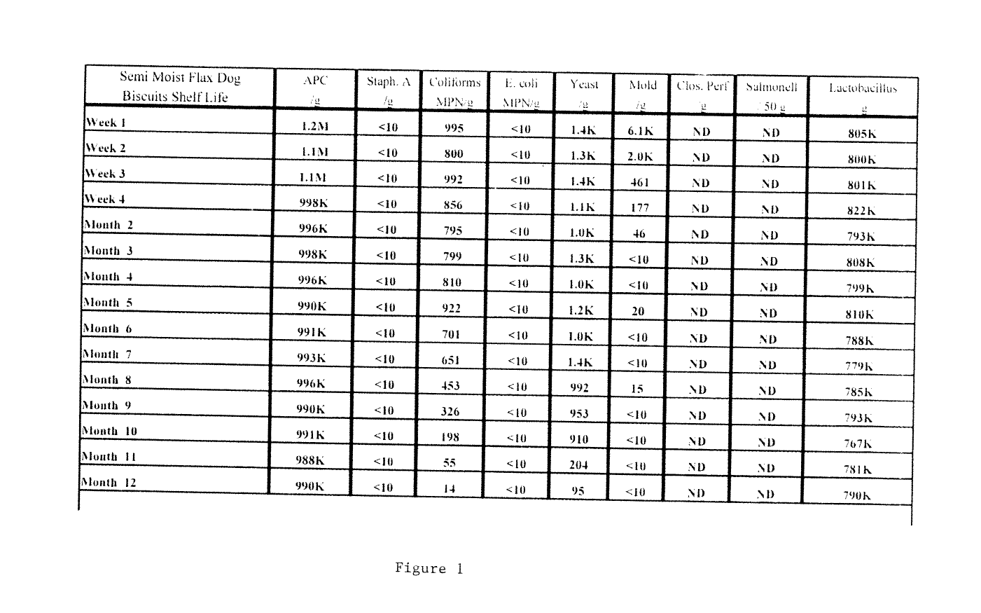

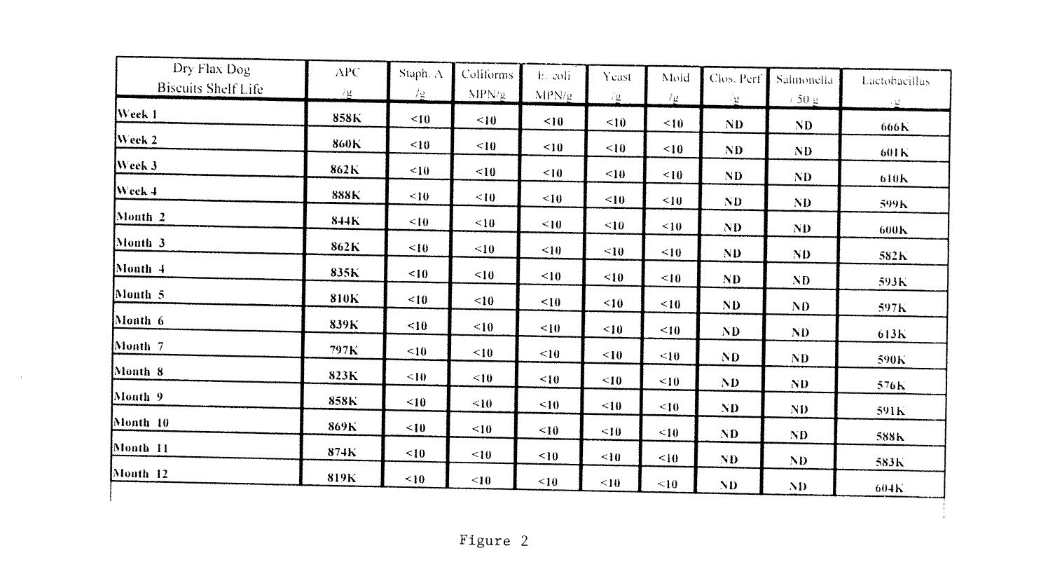

The pet food formulation includes at least one type of beneficial or probiotic bacteria. Preferably, the pet food formulation has both lactobacillus and bifidobacteria. As shown in FIG. 1, the embodiment of the pet food formulation formulated as semi-moist biscuits has a content of lactobacillus ranging from 805,000 colony forming units (cfu) at week 1 to 790,000 cfu at month 12. As shown in FIG. 2, the embodiment of the pet food formulation formulated as dry biscuits has a content of lactobacillus ranging from 666,000 cfu at week 1 to 790,000 cfu at month 12.

To process and cook the pet food composition in order to make dry baked biscuits or semi-moist biscuits in the form of an end product to be consumed by a pet, a pre-mix comprising all of the ingredients of the pet food composition are blended with enough warm water for processing, in a mixer for approximately 5 minutes to form a food composition. Typically about a 300 kg batch of the food composition is mixed with enough water for processing where the temperature of the water is in the range of 50° C. to 120° C.

After the mixing step, the resulting food composition is delivered to a rotary molder for pressing. Preferably, the rotary molder has a small rectangular die. The pressing step produces a formed food composition.

The formed food composition is then preferably sequentially delivered through individual zones of an oven preferably having at least three zones. An acceptable oven for the purposes of the present invention is an indirect flame three zone oven.

Preferably, a pasteurization step is then applied to the food composition. This step is for the purpose of reducing the amount of pathogenic bacteria such as salmonella that may be present in the food composition while preserving enough of the beneficial bacteria to allow the food composition to be probiotically active. Hence some bacteria are killed but not all. This allows the later cooking steps to be carried out at a lower temperature than would otherwise be needed to eliminate pathogenic bacteria.

The pasteurization step is applied to the food composition in the first zone of the oven. Preferably, the first zone of the oven is set at a temperature of between 220° C. to 343° C. and provides a resulting internal temperature of the food composition of between 90° C. to 120° C. The preferred internal temperature for the dry formulation is between 90° C. to 100° C. The preferred internal temperature for the semi moist formulation is between 90° C. to 120° C. The food composition is preferably kept in the first zone for about 4 minutes to 7 minutes.

Cooking steps are carried out in the second and third zones of the oven. The food composition is preferably delivered the second zone of the oven. Preferably, the second zone of the oven is set at a temperature of between 120° C. to 315° C. and provides a resulting internal temperature of the food composition of between 70° C. to 120° C. The preferred temperature for the dry formulation is between 70° C. to 90° C. The preferred temperature for the semi-moist formulation is between 90° C. to 120° C. The food composition is preferably kept in the second zone for about 4 minutes to 7 minutes.

The food composition is then preferably delivered the third zone of the oven. Preferably, the third zone of the oven is set at a temperature of between 120° C. to 315° C. and provides a resulting internal temperature of the food composition of between 50° C. to 120° C. The preferred temperature for the dry formulation is between 50° C. to 90° C. The preferred temperature for the semi-moist formulation is between 90° C. to 120° C. The formed food product is preferably kept in the third zone for about 4 minutes to 7 minutes.

It is also possible to carry out the cooking step in a single oven. For a single oven, it is acceptable to set the oven at a temperature of between 220° C. to 343° C. to provide a resulting internal temperature of the food composition of between 90° C. to 120° C. The food composition is preferably kept in the oven for about 10 minutes to 20 minutes.

The moisture content of the food composition is reduced down to an optimum level of preferably between 10% and 18% using both the oven and a cooler drier.

The food composition is preferably packaged in plastic bags with minimum barriers associated therewith. A preferred package is Regular PET/MET PET/500 ga Poly having an oxygen transfer rate of cc/100 in2/24 hrs. The preferred moisture vapor transfer rate of the package is (g/100 in²/24 hrs). A metal film has the following specifications: 48 g PET/48 g PET MET/2.50 mil PE ClearMVTR 0.04 OTR 0.05. An appropriately sized oxygen scavenger pouch is provided for the package size.

The shelf life of the food composition is preferably 12 months or greater.

### EXAMPLES

The following are examples of the pet food composition formulated as dry baked biscuits with the content of the elements of the compositions shown in terms of percent by weight.

Dry Baked Biscuits
Example 1
Fresh Breath and Tarter Control
Green Tea and Mint
Ingredient Declaration

| | |
|---|---|
| Ground Barley Flour | 25.00 |
| Germinated Flax Seed | 25.00 |
| Chicken | 10.00 |
| Ground Oats | 10.00 |
| Ground Brown Rice | 10.00 |
| Molasses | 5.00 |
| Canola oil | 4.00 |
| Vitamin and Mineral | 0.60 |
| Dicalcium Phosphate | |
| Vitamin E Acetate | |
| Choline Chloride | |
| Zinc Sulphate | |
| Vitamin A Palmitate | |
| Vitamin D3 Supplement | |
| Copper Sulphate | |
| Vitamin B2 | |
| Calcium Pantothenate | |
| Mixed Tocopherols | 0.40 |
| Green Tea | 0.05 |
| Mint | 0.02 |
| | 90.07 |

Guaranteed Analysis

| | |
|---|---|
| Crude Protein | 0.10 Minimum |
| Crude Fat | 0.05 Minimum |
| Crude Fiber | 0.14 Maximum |
| Moisture | 0.12 Maximum |

Example 2
Sensitive Stomach
Chicken and Rice
Ingredient Declaration

| | |
|---|---|
| Ground Barley Flour | 25.00 |
| Germinated Flax Seed | 25.00 |
| Chicken | 10.00 |
| Ground Oats | 10.00 |
| Ground Brown Rice | 10.00 |
| Molasses | 5.00 |
| Canola oil | 4.00 |
| Vitamin and Mineral | 0.60 |
| Dicalcium Phosphate | |
| Vitamin E Acetate | |
| Choline Chloride | |
| Zinc Sulphate | |
| Vitamin A Palmitate | |
| Vitamin D3 Supplement | |
| Copper Sulphate | |
| Vitamin B2 | |
| Calcium Pantothenate | |
| Mixed Tocopherols | 0.40 |
| | 90.00 |

Guaranteed Analysis

| | |
|---|---|
| Crude Protein | 10.0% Minimum |
| Crude Fat | 5.0% Minimum |
| Crude Fiber | 14.0% Maximum |
| Moisture | 12.0% Maximum |

The following are examples of the pet food composition formulated as semi-moist biscuits with the content of the elements of the compositions shown in terms of percent by weight.

Semi Moist Biscuits
Example 3
Healthy Hip and Joints
Chicken and Sweet Potato
Ingredient Declaration

| | |
|---|---|
| Ground Barley Flour | 25.00 |
| Germinated Flax Seed | 25.00 |
| Chicken | 20.00 |
| Ground Oats | 10.00 |
| Ground Brown Rice | 10.00 |
| Molasses | 10.00 |
| Sweet Potato | 5.00 |
| Canola oil | 4.00 |
| Vitamin and Mineral | 0.60 |
| Dicalcium Phosphate | |
| Vitamin E Acetate | |
| Choline Chloride | |
| Zinc Sulphate | |
| Vitamin A Palmitate | |
| Vitamin D3 Supplement | |
| Copper Sulphate | |
| Vitamin B2 | |
| Calcium Pantothenate | |
| Mixed Tocopherols | 0.40 |
| Beta Carotene | 0.03 |
| | 110.03 |

Guaranteed Analysis

| | |
|---|---|
| Crude Protein | 10.0% min |
| Crude Fat | 5.0% min |
| Crude Fiber | 14.0% max |
| Moisture | 16.0% max |

Example 4
Healthy Vitality
Salmon and Carrot
Ingredient Declaration

| | |
|---|---|
| Ground Barley Flour | 25.00 |
| Germinated Flax Seed | 25.00 |
| Salmon | 10.00 |
| Chicken | 10.00 |
| Ground Oats | 10.00 |
| Ground Brown Rice | 10.00 |
| Molasses | 10.00 |
| Carrot | 5.00 |
| Canola oil | 4.00 |
| Vitamin and Mineral | 0.60 |
| Dicalcium Phosphate | |
| Vitamin E Acetate | |
| Choline Chloride | |
| Zinc Sulphate | |
| Vitamin A Palmitate | |
| Vitamin D3 Supplement | |
| Copper Sulphate | |
| Vitamin B2 | |
| Calcium Pantothenate | |
| Mixed Tocopherols | 0.40 |
| | 110.00 |

Guaranteed Analysis

| | |
|---|---|
| Crude Protein | 10.0% |
| Crude Fat | 5.0% |
| Crude Fiber | 14.0% |
| Moisture | 16.0% |

Example 5
Immune Booster
Apples and Blueberries
Ingredient Declaration

| | |
|---|---|
| Ground Barley Flour | 25.00 |
| Germinated Flax Seed | 25.00 |
| Chicken | 20.00 |
| Ground Oats | 10.00 |
| Ground Brown Rice | 10.00 |
| Molasses | 10.00 |
| Canola oil | 4.00 |
| Apples | 3.00 |
| Blueberries | 3.00 |
| Vitamin and Mineral | 0.60 |
| Dicalcium Phosphate | |
| Vitamin E Acetate | |
| Choline Chloride | |
| Zinc Sulphate | |
| Vitamin A Palmitate | |
| Vitamin D3 Supplement | |
| Copper Sulphate | |
| Vitamin B2 | |
| Calcium Pantothenate | |
| Mixed Tocopherols | 0.40 |
| Beta Carotene | 0.03 |
| | 111.03 |

Guaranteed Analysis

| | |
|---|---|
| Crude Protein | 10.0% |
| Crude Fat | 5.0% |
| Crude Fiber | 14.0% |
| Moisture | 16.0% |

### Example 6

### Guaranteed Analysis

| Dry Formulation | Semi Moist Formulation |
|---|---|
| Crude Protein 5-30% | Crude Protein 5-30% |
| Crude Fat 1-25% | Crude Fat 1-25% |
| Crude Fiber 5-25% | Crude Fiber 5-25% |
| Moisture 2-20% | Moisture 2-30% |

While certain representative embodiments and details have been shown for purposes of illustrating the invention, it will be apparent to those skilled in the art that various changes in the methods and apparatus disclosed herein may be made without departing from the scope of the invention, which is defined in the appended claims.

What I claim is:

1. A probiotically and prebiotically active food composition comprising:
a germinated seed or grain;
probiotic bacteria;
a ground dry carbohydrate; and
a humectant.

2. A probiotically and prebiotically active food composition according to claim 1 wherein the germinated seed or grain is germinated flax seed.

3. A probiotically and prebiotically active food composition according to claim 1 wherein the germinated seed or grain is selected form the group consisting of chia seed, rice, whole grain wheat, oat, buckwheat, broccoli seed, carrot seed, adzuki bean, almond, amaranth, annatto seed, anise seed, argula, basil, brown rice, navy bean, pinto bean, lima bean, cabbage canola seed, caragana, cauliflower, celery, chick peas, chives, cilantro/coriander/dhania, clover, cress, dill fennel, fenugreek, garlic, hemp, kale, kamut, kat, leek, green lentil, lupins, pearl millet, mizuna, mustard, onion, black-eyed peas, green peas, pigeon peas, snow peas, peanut, psyllium, quinoa, radish, rye, sesame, soybean, tatsoi, triticale, water cress and wheat berries.

4. A probiotically and prebiotically active food composition according to claim 1 wherein the food composition is substantially free of added salt and refined sugar.

5. A probiotically and prebiotically active food composition according to claim 1 wherein the ground dry carbohydrate is a grain flour.

6. A probiotically and prebiotically active food composition according to claim 5 wherein the grain flour is barley flour.

7. A probiotically and prebiotically active food composition according to claim 1 wherein the humectant is molasses or honey.

8. A probiotically and prebiotically active food composition according to claim 1 wherein the composition has a fructooligosaccharide content of greater than 5 mg/g.

9. A probiotically and prebiotically active food composition according to claim 1 wherein the composition has a fructooligosaccharide content of greater than 10 mg/g.

10. A probiotically and prebiotically active food composition according to claim 1 wherein the composition has a mannooligosaccharide content of greater than 5 mg/g.

11. A probiotically and prebiotically active food composition according to claim 1 wherein the composition further comprises an edible oil.

12. A probiotically and prebiotically active food composition according to claim 1 wherein the composition further comprises an edible oil.

13. A probiotically and prebiotically active food composition according to claim 1 wherein the probiotic bacteria comprise lactobacillus or bifidobacteria.

14. A probiotically and prebiotically active food composition according to claim 1 wherein the probiotic bacteria comprise lactobacillus and bifidobacteria.

15. A probiotically and prebiotically active food composition according to claim 1 wherein the composition is formulated in the form of a dry baked biscuit.

16. A probiotically and prebiotically active food composition according to claim 1 wherein the composition is formulated in the form of a semi moist biscuit.

17. A method of preparing a probiotically and prebiotically active food composition comprising the following steps:
providing a pre-mix composition comprising a germinated seed or grain, a ground dry carbohydrate, probiotic bacteria and a humectant;
blending the pre-mix composition with water;
mixing the pre-mix composition to form a food composition;
cooking the food composition in an oven at an internal temperature of the food composition of not greater than about 120° C. for about 10 minutes to 20 minutes.

18. A method according to claim 17 further comprising the step of pasteurizing the food composition prior to cooking the food composition.

19. A method of preparing a probiotically and prebiotically active food composition comprising the following steps:
providing a pre-mix composition comprising a germinated seed or grain, a ground dry carbohydrate, probiotic bacteria and a humectant;
blending the pre-mix composition with water;
mixing the pre-mix composition to form a food composition;
pasteurizing the food composition in a first oven zone, the first oven zone being set to create an internal temperature of the food composition of between 90° C. and 120° C.;
cooking the food composition in a second oven zone, the second oven zone being set to create an internal temperature of the food composition of between 70° C. and 120° C.;
cooking the food composition in a third oven zone, the third oven zone being set to create an internal temperature of the food composition of between 50° C. and 120° C.

20. A method according to claim 19 further comprising the step of reducing a moisture level of the food composition to below 12% in the third zone of the oven.
